(19) United States
(12) Patent Application Publication
(10) Pub. No.: US 2023/0331346 A1
(43) Pub. Date: Oct. 19, 2023

(54) SYSTEMS AND METHODS OF ADJUSTABLE SUSPENSIONS FOR OFF-ROAD RECREATIONAL VEHICLES

(71) Applicant: Polaris Industries Inc., Medina, MN (US)

(72) Inventor: Cody L. Telford, Sandpoint, ID (US)

(73) Assignee: Polaris Industries Inc., Medina, MN (US)

(21) Appl. No.: 18/133,882

(22) Filed: Apr. 12, 2023

Related U.S. Application Data
(60) Provisional application No. 63/330,968, filed on Apr. 14, 2022.

(51) Int. Cl. B62M 27/02

(52) U.S. Cl. CPC B62M 27/02; B62M 2027/026; B62M 2027/025

(57) ABSTRACT

A tracked vehicle may include a plurality of ground engaging members coupled to a frame through a plurality of suspensions, the plurality of suspensions including at least one adjustable shock absorber.

### RELATED APPLICATIONS

The present application claims priority to U.S. Provisional Application Ser. No. 63/330,968, filed on Apr. 14, 2022, and entitled “SYSTEMS AND METHODS OF ADJUSTABLE SUSPENSIONS FOR OFF-ROAD RECREATIONAL VEHICLES”, the complete disclosure of which is expressly incorporated by reference herein.

### FIELD

The present disclosure relates to improved suspension for off-road recreational vehicles and, in particular, to systems and methods of damping control for shock absorbers of off-road recreational vehicles including tracked vehicles.

### BACKGROUND

Currently some off-road vehicles include adjustable shock absorbers. These adjustments include spring preload, high and low speed compression damping and/or rebound damping. In order to make these adjustments, the vehicle is stopped and the operator makes an adjustment at each shock absorber location on the vehicle. A tool is often required for the adjustment. Some off-road vehicles also include adjustable electric shocks along with sensors for active ride control systems.

### SUMMARY

In one embodiment of the present disclosure, a tracked vehicle is provided. The tracked vehicle comprises a vertical longitudinal vehicle centerline plane and a plurality of ground engaging members. The plurality of ground engaging members include an endless track having an endless track width defined between a first lateral side of the endless track and a second lateral side of the endless track. The tracked vehicle also includes a ski positioned forward of the endless track, and the ski has a ski width defined between a first lateral side of the ski and a second lateral side of the ski. The first lateral side of the ski is positioned between the longitudinal vehicle centerline plane and the first lateral side of the endless track. The tracked vehicle also includes a frame supported by the plurality of ground engaging members and a plurality of suspensions. The plurality of suspensions comprise a first suspension coupling the ski to the frame and a second suspension positioned within an interior of the endless track. Further, at least one of the plurality of suspensions includes at least one adjustable shock absorber having at least one adjustable damping characteristic. The tracked vehicle also includes an electronic controller supported by the plurality of ground engaging members and operatively coupled to the at least one adjustable shock absorber to control the at least one adjustable damping characteristic of the at least on adjustable shock absorber. The tracked vehicle also includes a straddle seat supported by the frame, a prime mover operatively coupled to the endless track to power movement of the endless track, and a steering input operatively coupled to the ski to control an orientation of the ski.

Further, the plurality of suspensions comprise a third suspension coupling the endless track to the frame. One of the first suspension and the second suspension includes a first adjustable shock absorber of the at least one adjustable shock absorber and the third suspension includes a third suspension adjustable shock absorber of the at least one adjustable shock absorber. Further, the second lateral side of the ski is positioned between the longitudinal vehicle centerline plane and one of the first lateral side of the endless track and the second lateral side of the endless track. Additionally, the first lateral side of the ski is positioned on a first side of the vertical longitudinal vehicle centerline plane and the second lateral side of the ski is positioned on a second side of the vertical longitudinal vehicle centerline plane.

Further, the ski width is centered about the vertical longitudinal vehicle centerline plane. Additionally, the endless track width is centered about the vertical longitudinal vehicle centerline plane. In additional embodiments, both the first lateral side of the ski and the second lateral side of the ski are positioned on one of a first side of the vertical longitudinal vehicle centerline plane and a second side of the vertical longitudinal vehicle centerline plane. Further, the ski is a first ski positioned completely on the first side of the vertical longitudinal vehicle centerline plane and the plurality of ground engaging members further includes a second ski positioned completely on the second side of the vertical longitudinal vehicle centerline plane. Further, the first suspension couples the first ski to the frame and the plurality of suspensions further comprises a fourth suspension coupling the second ski to the frame.

In additional embodiments, the tracked vehicle further comprises an operator input actuatable by the operator to alter the at least one adjustable damping characteristic of the at least one adjustable shock absorber. Further, in response to an actuation of the operator input a compression damping characteristic of the at least one adjustable shock absorber is stiffened. In additional embodiments, the first suspension includes a first suspension adjustable shock absorber of the at least one adjustable shock absorber and in response to an actuation of the operator input a compression damping characteristic of the first suspension adjustable shock absorber is stiffened. Further, the second suspension includes a second suspension adjustable shock absorber of the at least one adjustable shock absorber. In response to an actuation of the operator input one of a compression damping characteristic of the second suspension adjustable shock absorber and a rebound damping characteristic of the second suspension adjustable shock absorber is altered.

Further, in response to an actuation of the operator input one of a compression damping characteristic of the third suspension adjustable shock absorber and a rebound damping characteristic of the third suspension adjustable shock absorber is altered. In additional embodiments, at least one sensor is supported by the plurality of ground engaging members and operatively coupled to the electronic controller to alter the at least one adjustable damping characteristic of the at least one adjustable shock absorber. Further, the first suspension includes a first suspension adjustable shock absorber of the at least one adjustable shock absorber. In response to a vehicle characteristic determined by the electronic controller based on the at least one sensor, a compression damping characteristic of the at least one adjustable shock absorber is stiffened.

Additionally, the second suspension includes a second suspension adjustable shock absorber of the at least one adjustable shock absorber. In response to a vehicle characteristic determined by the electronic controller based on the at least one sensor one of a compression damping characteristic of the second suspension adjustable shock absorber and a rebound damping characteristic of the second suspension adjustable shock absorber is altered. Additionally, in response to a vehicle characteristic determined by the electronic controller based on the at least one sensor one of a compression damping characteristic of the third suspension adjustable shock absorber and a rebound damping characteristic of the third suspension adjustable shock absorber is altered. Further, the vehicle characteristic is one of a speed of the tracked vehicle, an acceleration of the tracked vehicle, a braking of the tracked vehicle, an airborne status of the tracked vehicle, and a turning of the tracked vehicle.

Additional features of the present disclosure will become apparent to those skilled in the art upon consideration of the following detailed description of illustrative embodiments exemplifying the best mode of carrying out the invention as presently perceived.

### BRIEF DESCRIPTION OF THE DRAWINGS

The foregoing aspects and many additional features of the present system and method will become more readily appreciated and become better understood by reference to the following detailed description when taken in conjunction with the accompanying drawings.

FIG. 1 illustrates a side view of an exemplary embodiment of a snowbike;

FIG. 1A illustrates a representative top view of the exemplary embodiment of the snowbike of FIG. 1;

FIG. 2 illustrates a side view of another exemplary embodiment of a snowbike;

FIG. 3 illustrates a side view of a further exemplary embodiment of a snowbike;

FIG. 4 illustrates a side view of an exemplary embodiment of a rear suspension of a snowbike;

FIG. 5 illustrates a side view of another exemplary embodiment of a rear suspension of a snowbike;

FIG. 6 illustrates a side view of a further exemplary embodiment of a rear suspension of a snowbike;

FIG. 7 illustrates a side view of yet another exemplary embodiment of a rear suspension of a snowbike;

FIG. 8 illustrates a side view of still another exemplary embodiment of a rear suspension of a snowbike;

FIG. 9 illustrates a side view of yet a further exemplary embodiment of a rear suspension of a snowbike;

FIG. 10 illustrates a side view of an exemplary embodiment of a front suspension of a snowbike;

FIG. 11 illustrates a side view of another exemplary embodiment of a front suspension of a snowbike;

FIG. 12 illustrates a side view of a further exemplary embodiment of a front suspension of a snowbike;

FIG. 13 illustrates a side view of yet another exemplary embodiment of a front suspension of a snowbike;

FIG. 14 illustrates a side view of still another exemplary embodiment of a front suspension of a snowbike;

FIG. 15 illustrates a side view of yet a further exemplary embodiment of a front suspension of a snowbike;

FIG. 15A illustrates a representative top view of the exemplary embodiment of the snowbike of FIG. 15; and

FIG. 16 illustrates a representative view of a control system of a snowbike.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure.

### DETAILED DESCRIPTION OF THE DRAWINGS

For the purposes of promoting an understanding of the principles of the present disclosure, reference is now made to the embodiments illustrated in the drawings, which are described below. The embodiments disclosed below are not intended to be exhaustive or limit the present disclosure to the precise form disclosed in the following detailed description. Rather, the embodiments are chosen and described so that others skilled in the art may utilize their teachings. Therefore, no limitation of the scope of the present disclosure is thereby intended. Corresponding reference characters indicate corresponding parts throughout the several views.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

In some instances throughout this disclosure and in the claims, numeric terminology, such as first, second, third, and fourth, is used in reference to various operative transmission components and other components and features. Such use is not intended to denote an ordering of the components. Rather, numeric terminology is used to assist the reader in identifying the component being referenced and should not be narrowly interpreted as providing a specific order of components.

In various embodiments, snow bikes are known to have a variety of configurations, including various frame configurations, front suspension configurations, rear suspension configurations, and driveline configurations. The enclosed disclosure is not intended to be limited to a single type of configuration or combination of the various embodiments and should not be interpreted as limited to those embodiments. For the purpose of increasing understanding, and enhancing the description herein, various embodiments of a snowbike will be described in greater detail. More specifically, snowbikes created using a conversion kit, where a traditional motorized bicycle may be converted into a snowbike by disconnecting a rear swing arm and replacing it with a track-style rear suspension. This type of conversion kit is known in the art, additional details of which may be found in the disclosure of U.S. Pat. No. 8,910,738, issued Dec. 16, 2014, and entitled “SNOW BIKE CONVERSION SYSTEM,” the entire disclosure of which is expressly incorporated by reference herein. Additionally, purpose-built snowbikes have been described in various embodiments, wherein the rear suspension is purposely built and integrated into the snowbike 10. This type of snowbike provides different advantages, additional details of which may be found in the disclosure of U.S. Published Patent Application Serial No. US20210053652A1, filed Aug. 18, 2020, and entitled “SNOW VEHICLE,” the entire disclosure of which is expressly incorporated by reference herein. Exemplary systems are disclosed in U.S. Pat. Nos. 10,202,169, 10,538,262, and US Published Patent Application No. 2020/0148291, the entire disclosures of each expressly incorporated by reference herein.

As described herein, various embodiments of snowbikes are disclosed having one or more adjustable shock absorbers which are electronically controlled with an electronic controller to adjust one or damping characteristics of the one or more adjustable shock absorbers. Additional details regarding exemplary shock absorbers, sensors monitored to provide vehicle characteristics used to adjust damping characteristics, and operator inputs used to adjust damping characteristics are provided in U.S. Pat. No. 9,010,768; US Published Patent Application No. 2016/0059660; U.S. Pat. Nos. 10,406,884; 9,381,810; and US Published Patent Application No. 2021/0362806, the entire disclosures of which are expressly incorporated by reference herein.

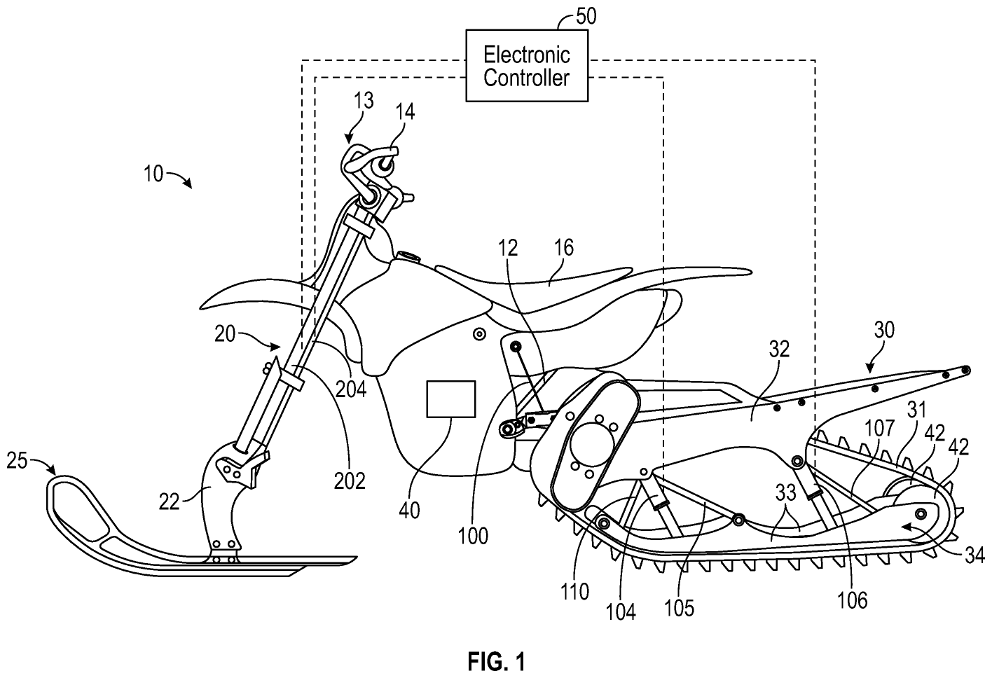

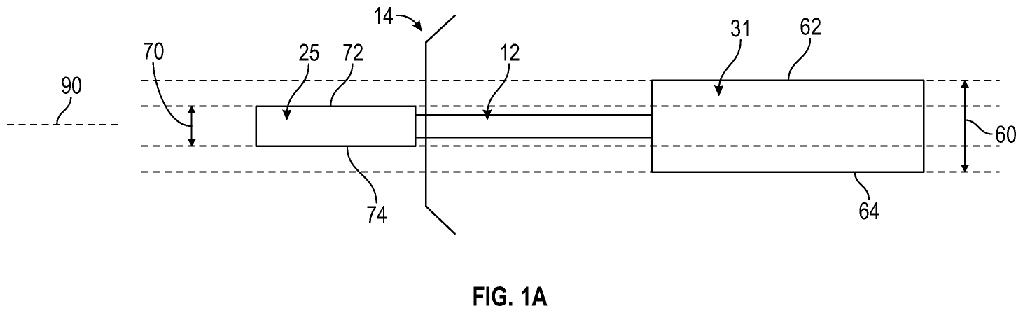

It is understood that in various embodiments, various structures may be configured in different orientations, however, it is also conceived that the various embodiments may comprise substantially similar components. Turning to FIGS. 1-3, a snowbike 10 may comprise a frame 12 and a steering system 13 coupled at the front of frame 12. Steering system 13 may further comprise a plurality of handlebars 14. In various embodiments, handlebars 14 may be a single handlebar, a steering wheel, or other steering implement. Steering system 13 may be coupled to a ski 25 through a front suspension 20. Front suspension 20 may be configured in a variety of configurations and will be described in greater detail below. Steering system 13 may be configured to steer ski 25 by an operator applying a force to handlebars 14, thus transmitting a rotational force through steering system 13 to ski 25. Frame 12 may further be configured to support a seat 16 positioned generally rearward of steering system 13, seat 16 may be configured to support at least one rider. In embodiments, seat 16 may support two or more riders. Snowbike 10 may further comprise a rear suspension assembly 30 operatively coupled to frame 12 through various mounting methods. Snowbike 10 may be comprise a prime mover 40 configured to provide propulsion to snowbike 10, and more specifically provide power to an endless track 31. Exemplary prime movers include two-cycle combustion engines, four-cycle combustion engines, electric motors, and other suitable motive devices. Prime mover 40 is operatively coupled to endless track 31 through a transmission. Exemplary transmissions include shiftable transmissions, continuously variable transmissions, and combinations thereof. Methods of providing power to endless track 31 through a prime mover 40 are disclosed in U.S. Pat. No. 9,873,485, issued Jan. 23, 2018, and entitled “SNOW VEHICLE,” the entire disclosure of which is expressly incorporated herein.

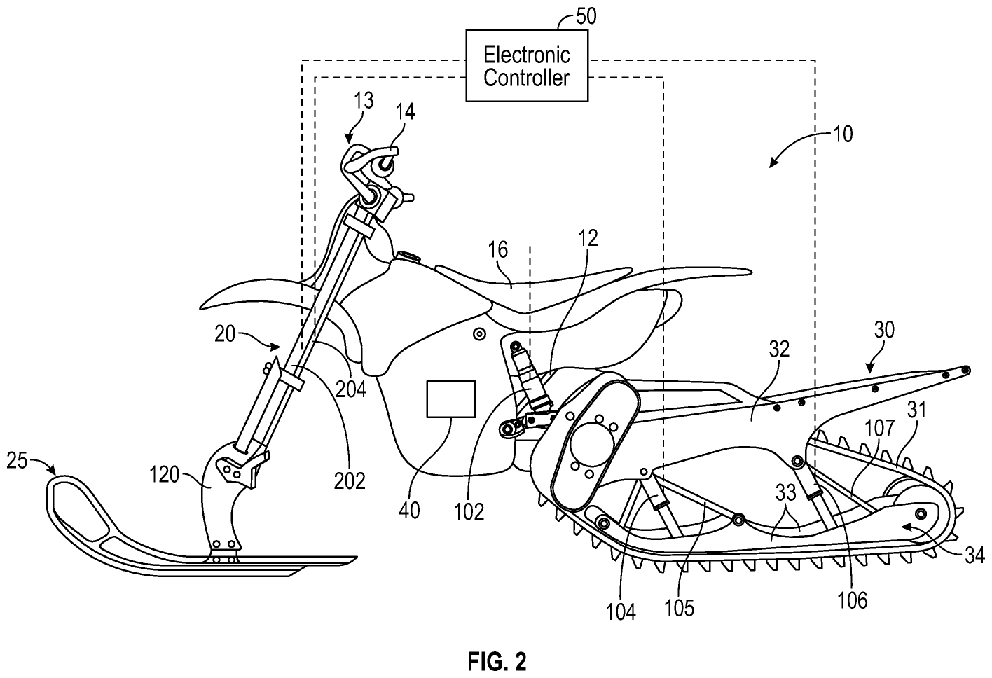

Still referring to FIGS. 1-3, rear suspension assembly 30 may comprise a plurality of components. Illustratively, rear suspension assembly 30 may comprise a tunnel 32 located generally above endless track 31. In various embodiments, tunnel 32 may cover the entirety of an endless track 31, and in other embodiments, tunnel 32 may only cover a portion of endless track 31. Rear suspension assembly 30 is rotatably coupled to frame 12. Referring to FIG. 1, rear suspension assembly 30 and frame 12 are coupled together with a suspension including a fixed strut 100. Referring to FIG. 2, rear suspension assembly 30 and frame 12 are coupled together with a suspension including a rear frame shock absorber 102. In various embodiments, rear frame shock absorber 102 may be an adjustable shock absorber and may provide additional damping and/or rebound between frame 12 and rear suspension assembly 30. The mounting of a fixed strut 100 or movable strut between frame 12 and rear suspension assembly 30 is disclosed in U.S. Pat. No. 10,889,338, issued Jan. 12, 2021, and entitled “SNOW VEHICLE,” the entire disclosure of which is expressly incorporated herein.

Rear suspension assembly 30 may further comprise a skid 34 configured with a plurality of slide rails 33 positioned within an interior of endless track 31, and alternatively, a single slide rail. Additionally, rear suspension assembly 30 may also include a front track shock absorber 104 positioned inside of an interior of endless track 31, and a rear track shock absorber 106 positioned inside of an interior of endless track 31. Additionally, rear suspension assembly 30 may comprise a first torque arm 105 and a second torque arm 107 rotatably mounted to skid 34. Skid 34 may provide a plurality of supports configured to couple to a front track shock absorber 104 and a rear track shock absorber 106. front track shock absorber 104 and rear track shock absorber 106 may further be configured to couple to tunnel 32 at a plurality of mounting locations or mounted to one or more of suspension arms 105, 107. In the present embodiment, first torque arm 105 is positioned rearward of front track shock absorber 104 and forward of rear track shock absorber 106. Further, second torque arm 107 may be located rearward of rear track shock absorber 106. In one embodiment, first torque arm 105 and second torque arm 107 may be comprised of forged aluminum, which may reduce the overall weight of snowbike 10. In various embodiments, both front track shock absorber 104 and rear track shock absorber 106 are adjustable shock absorbers, and in yet additional embodiments, only one front track shock absorber 104 or rear track shock absorber 106 may be an adjustable shock absorber. While the present embodiment describes a first rear suspension arrangement, a variety of additional rear suspension arrangements will be described in greater detail below.

Rear suspension assembly 30 may also include a plurality of rear idler wheels 42 rotatably coupled to the rear end of slide rails 33 and a plurality of carrier wheels (not shown) laterally adjacent the rear, upper end of rear track shock absorber 106. Rear idler wheels 42 and carrier wheels are configured to maintain tension in endless track 31. Additionally, the position of rear idler wheels 42 on slide rails 33 may be adjusted to adjust the tension in endless track 31. As shown in FIGS. 1-3, endless track 31 generally surrounds rear suspension assembly 30 and is supported on at least slide rails 33, rear idler wheels 42, and carrier wheels 44 (not shown). Rear suspension assembly 30 is configured to cooperate with endless track 31 when snowbike 10 is operating. In particular, rear suspension assembly 30 is configured to move longitudinally and vertically during operation of snowbike 10, and the tension in endless track 31 is maintained throughout the movement of rear suspension assembly 30 by at least rear idler wheels 42.

Referring to FIG. 1A, endless track 31 has an endless track width 60 defined between a first lateral side 62 of the endless track 31 and a second lateral side 64 of the endless track 31. Ski 25 is positioned forward of endless track 31. Ski 25 has a ski width 70 defined between a first lateral side 72 of the ski 25 and a second lateral side 74 of the ski 25. First lateral side 72 of the ski 25 being positioned between a longitudinal vehicle centerline plane 90 of snowbike 10 and the first lateral side 62 of the endless track 31. The second lateral side 74 of the ski 25 is positioned between the longitudinal vehicle centerline plane 90 and the second lateral side 64 of the endless track 31. The first lateral side 72 of the ski 25 is positioned on a first side of the vertical longitudinal vehicle centerline plane 90 and the second lateral side 74 of the ski 25 is positioned on a second side of the vertical longitudinal vehicle centerline plane 90.

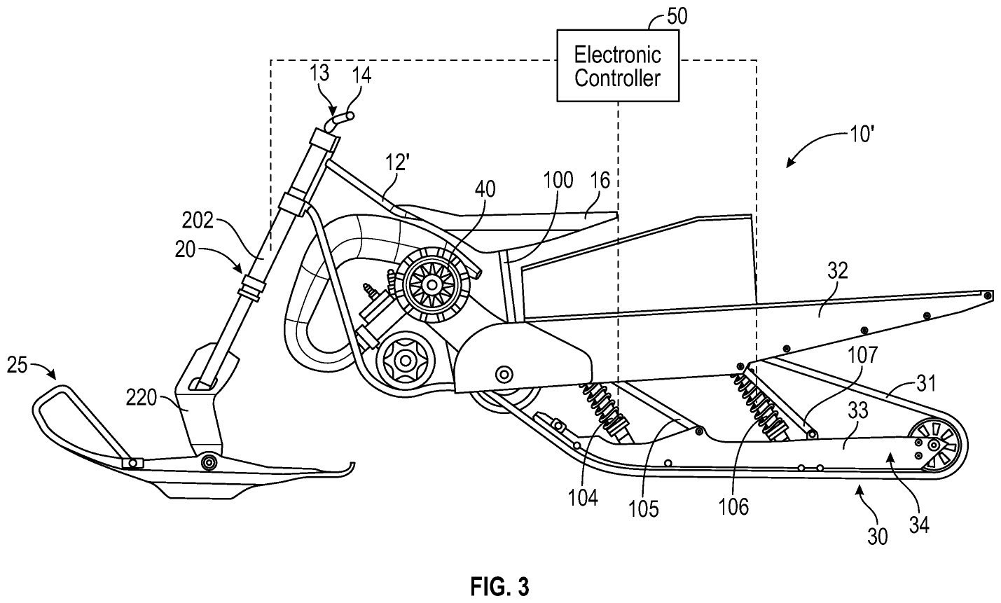

Referring to FIG. 3, a snowbike 10′ is shown with an alternate frame 12′. It may be appreciated that while snowbike 10′ is constructed differently than snowbike 10, snowbike 10′ may comprise similar components and maintain similar functionality in some respects. In the present embodiment, snowbike 10′ comprises steering system 13 with handlebars 14 operably coupled to ski 25 through front suspension 20 and steering system 13. Snowbike 10′ further comprises a seat 16 supported by frame 12′, and prime mover 40, as previously explained. Snowbike 10′ may further comprise rear suspension assembly 30 comprising tunnel 32 and skid 34, and front track shock absorber 104, rear track shock absorber 106, first torque arm 105 and second torque arm 107. Snowbike 10′ may further include fixed strut 100 or rear frame shock absorber 102 positioned between frame 12′ and rear suspension assembly 30.

In various embodiments of snowbike 10 or snowbike 10′, rear suspension assembly 30 may further comprise a first strap 110. Straps 110 may be used to limit the travel of the plurality of front track shock absorber 104 and rear track shock absorber 106 as well as the first torque arm 105 and second torque arm 107. In embodiments, a single strap may be used, two straps may be used, or no straps may be used in rear suspension assembly 30. In various embodiments, any number of straps may be used in rear suspension assembly 30. Straps may be made of a hard rubber, or other material with rubber-like properties. As various suspensions are explained in greater detail below, various numbers of straps will be shown used in various suspension configurations.

Still referring to FIGS. 1-3, front suspension 20 may comprise a plurality of components including a spindle 22 coupled between ski 25 and a plurality of down tubes. Illustratively, down tubes may comprise a first front shock absorber 202 and a second front shock absorber 204. In various embodiments, first front shock absorber 202 may be an adjustable shock absorber and second front shock absorber 204 may be an adjustable shock absorber.

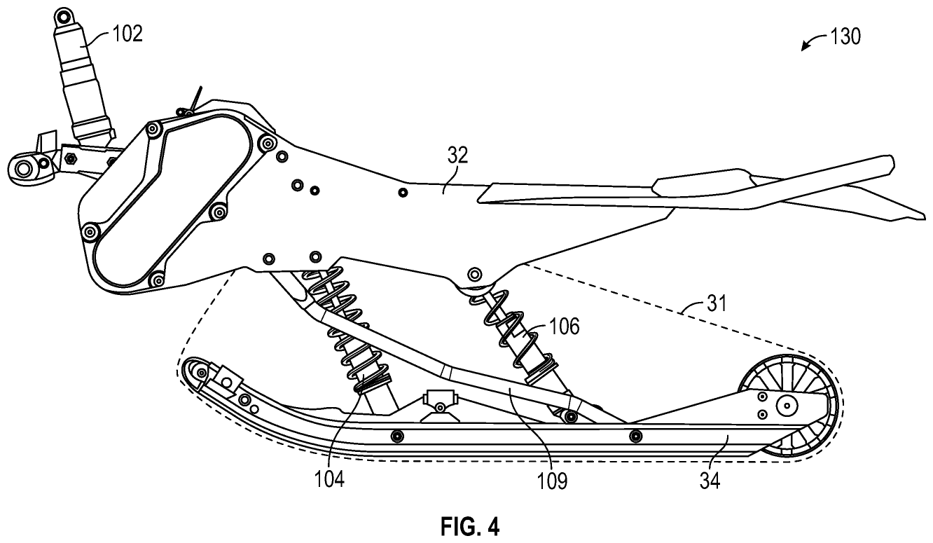

Turning now to FIG. 4, an alternate embodiment of rear suspension assembly 30 will be described in greater detail. In the present embodiment, a rear suspension 130 comprises front track shock absorber 104 and rear track shock absorber 106 which provide adjustable damping between tunnel 32 and skid 34. Additionally, a third torque arm 109 is pivotally connected to tunnel 32 and skid 34. More specifically, third torque arm 109 is pivotally coupled to tunnel 32 at a position forward of an upper portion of front track shock absorber 104, and third torque arm 109 is pivotally coupled to skid 34 at a position rearward of a lower extent of rear track shock absorber 106. In this way, rear suspension 130 comprises a single torque arm, third torque arm 109. In embodiments, the damping characteristics of front track shock absorber 104 are controlled by electronic controller 50 while rear frame shock absorber 102 and rear track shock absorber 106 are manually adjustable independent of electronic controller 50. In embodiments, the damping characteristics of rear track shock absorber 106 are controlled by electronic controller 50 while rear frame shock absorber 102 and front track shock absorber 104 are manually adjustable independent of electronic controller 50. In embodiments, the damping characteristics of rear frame shock absorber 102 are controlled by electronic controller 50 while front track shock absorber 104 and rear track shock absorber 106 are manually adjustable independent of electronic controller 50. In embodiments, the damping characteristics of rear frame shock absorber 102 and front track shock absorber 104 are controlled by electronic controller 50 while rear track shock absorber 106 is manually adjustable independent of electronic controller 50. In embodiments, the damping characteristics of front track shock absorber 104 and rear track shock absorber 106 are controlled by electronic controller 50 while rear frame shock absorber 102 is manually adjustable independent of electronic controller 50. In embodiments, the damping characteristics of rear frame shock absorber 102 and rear track shock absorber 106 are controlled by electronic controller 50 while front track shock absorber 104 is manually adjustable independent of electronic controller 50. In embodiments, the damping characteristics of rear frame shock absorber 102, front track shock absorber 104, and rear track shock absorber 106 are controlled by electronic controller 50.

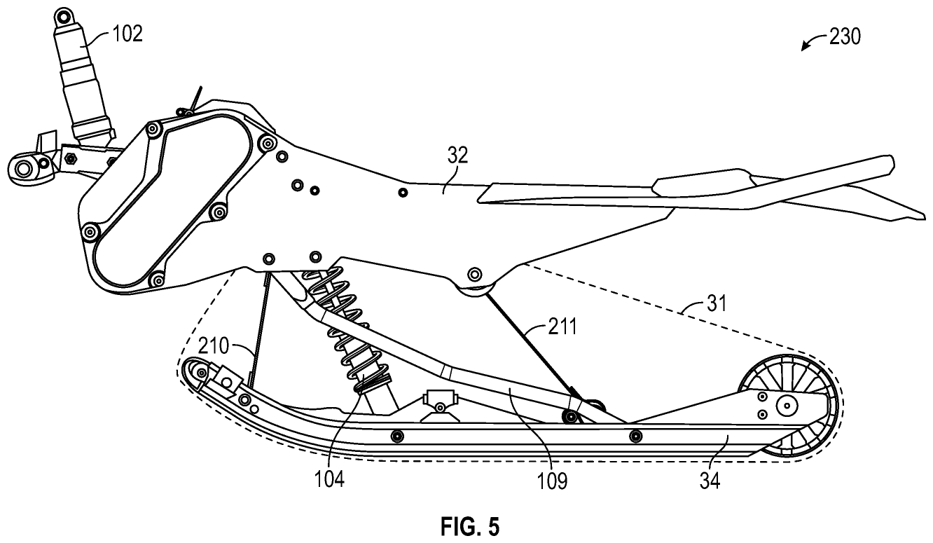

Turning now to FIG. 5, an alternate embodiment of rear suspension assembly 30 will be described in greater detail. In the present embodiment, a rear suspension 230 comprises front track shock absorber 104 which provides adjustable damping between tunnel 32 and skid 34. Additionally, third torque arm 109 is pivotally connected to tunnel 32 and skid 34. More specifically, third torque arm 109 is pivotally coupled to tunnel 32 at a position forward of an upper portion of front track shock absorber 104, and third torque arm 109 is pivotally coupled to skid 34 at a position rearward of a lower extent of front track shock absorber 104. In this way, rear suspension 130 comprises a single torque arm, third torque arm 109. Additionally, in the present embodiment, rear suspension 230 comprises a front strap 210 and a rear strap 211, wherein front strap is coupled between tunnel 32 and skid 34. Illustratively, front strap 210 is coupled to tunnel 32 at a position in front of the upper extent of front track shock absorber 104, and further, front strap 210 is coupled to tunnel 32 at a position coaxial with an upper extent of third torque arm 109 or coupled to the upper extent of third torque arm 109. Further, lower end of front strap 210 is coupled to a generally forward portion of skid 34. In the present embodiment, rear strap 211 is coupled in a position substantially similar to rear track shock absorber 106 of rear suspension 130. In this way, rear strap 211 is coupled to tunnel 32 at a position rearward of the upper extent of front track shock absorber 104, and rear strap 211 is coupled to skid 34 at a position forward of the lower extent of third torque arm 109. In embodiments, the damping characteristics of front track shock absorber 104 are controlled by electronic controller 50 while rear frame shock absorber 102 is manually adjustable independent of electronic controller 50. In embodiments, the damping characteristics of rear frame shock absorber 102 are controlled by electronic controller 50 while front track shock absorber 104 is manually adjustable independent of electronic controller 50. In embodiments, the damping characteristics of both rear frame shock absorber 102 front track shock absorber 104 are controlled by electronic controller 50.

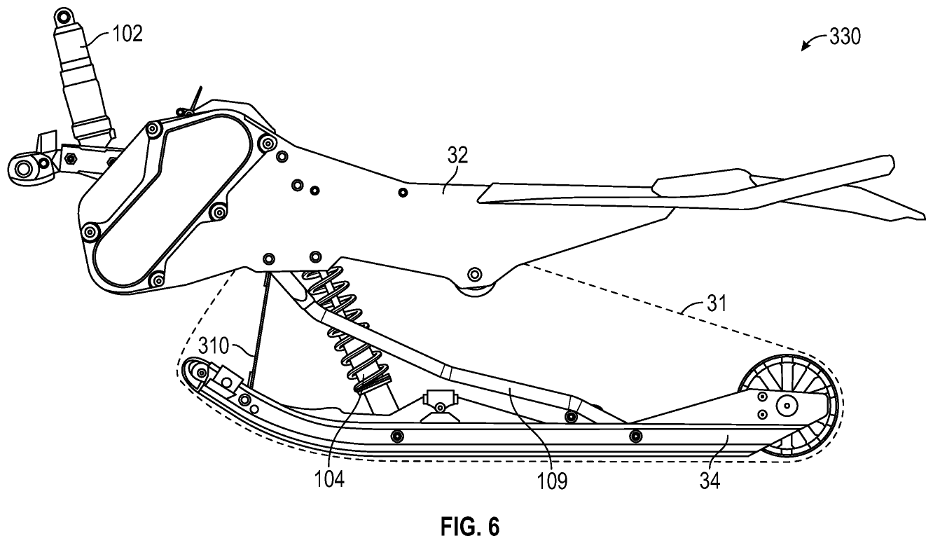

Turning now to FIG. 6, an alternate embodiment of rear suspension assembly 30 will be described in greater detail. In the present embodiment, a rear suspension 330 comprises front track shock absorber 104 which provides adjustable damping between tunnel 32 and skid 34. Additionally, third torque arm 109 is pivotally connected to tunnel 32 and skid 34. More specifically, third torque arm 109 is pivotally coupled to tunnel 32 at a position forward of an upper portion of front track shock absorber 104, and third torque arm 109 is pivotally coupled to skid 34 at a position rearward of a lower extent of front track shock absorber 104. In this way, rear suspension 130 comprises a single torque arm, third torque arm 109. Additionally, in the present embodiment, rear suspension 330 comprises a front strap 210, wherein front strap is coupled between tunnel 32 and skid 34. Illustratively, front strap 210 is coupled to tunnel 32 at a position in front of the upper extent of front track shock absorber 104, and further, front strap 210 is coupled to tunnel 32 at a position coaxial with an upper extent of third torque arm 109 or coupled to an upper extent of third torque arm 109. Further, lower end of front strap 210 is coupled to a generally forward portion of skid 34. In embodiments, the damping characteristics of front track shock absorber 104 are controlled by electronic controller 50 while rear frame shock absorber 102 is manually adjustable independent of electronic controller 50. In embodiments, the damping characteristics of rear frame shock absorber 102 are controlled by electronic controller 50 while front track shock absorber 104 is manually adjustable independent of electronic controller 50. In embodiments, the damping characteristics of both rear frame shock absorber 102 front track shock absorber 104 are controlled by electronic controller 50.

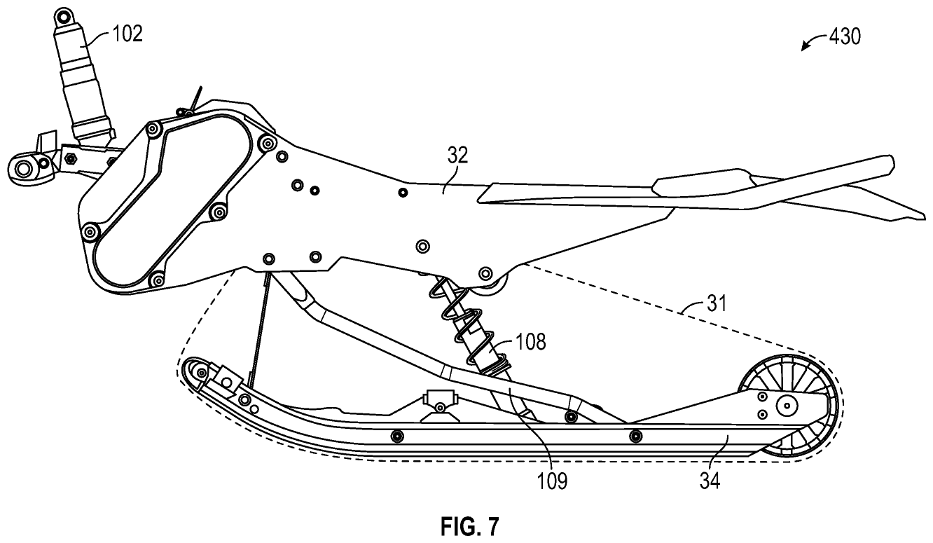

Turning now to FIG. 7, an alternate embodiment of rear suspension assembly 30 will be described in greater detail. In the present embodiment, a rear suspension 430 comprises intermediate track shock absorber 108 which provides adjustable damping between tunnel 32 and skid 34. In the present embodiment, intermediate track shock absorber 108 is coupled to a middle portion of tunnel 32 and a middle portion of skid 34. More specifically, third torque arm 109 is pivotally coupled to tunnel 32 at a position forward of an upper portion of intermediate track shock absorber 108, and third torque arm 109 is pivotally coupled to skid 34 at a position rearward of a lower extent of intermediate track shock absorber 108. In this way, rear suspension 130 comprises a single torque arm, third torque arm 109. Additionally, in the present embodiment, rear suspension 430 comprises a front strap 210, wherein front strap is coupled between tunnel 32 and skid 34. Illustratively, front strap 210 is coupled to tunnel 32 at a position in front of the upper extent of intermediate track shock absorber 108, and further, front strap 210 is coupled to tunnel 32 at a position coaxial with an upper extent of third torque arm 109 or coupled to the upper extent of third torque arm 109. Further, lower end of front strap 210 is coupled to a generally forward portion of skid 34. In embodiments, the damping characteristics of intermediate track shock absorber 108 are controlled by electronic controller 50 while rear frame shock absorber 102 is manually adjustable independent of electronic controller 50. In embodiments, the damping characteristics of rear frame shock absorber 102 are controlled by electronic controller 50 while front track shock absorber 104 is manually adjustable independent of electronic controller 50. In embodiments, the damping characteristics of both rear frame shock absorber 102 front track shock absorber 104 are controlled by electronic controller 50.

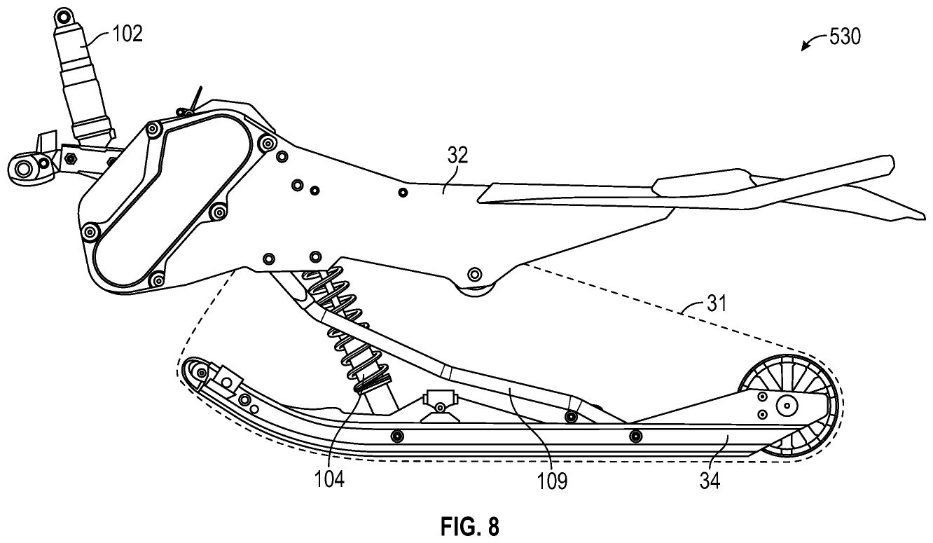

Turning now to FIG. 8, an alternate embodiment of rear suspension assembly 30 will be described in greater detail. In the present embodiment, a rear suspension 530 comprises front track shock absorber 104 which provides adjustable damping between tunnel 32 and skid 34. Additionally, third torque arm 109 is pivotally connected to tunnel 32 and skid 34. More specifically, third torque arm 109 is pivotally coupled to tunnel 32 at a position forward of an upper portion of front track shock absorber 104, and third torque arm 109 is pivotally coupled to skid 34 at a position rearward of a lower extent of front track shock absorber 104. In this way, rear suspension 130 comprises a single torque arm, third torque arm 109. In embodiments, the damping characteristics of front track shock absorber 104 are controlled by electronic controller 50 while rear frame shock absorber 102 is manually adjustable independent of electronic controller 50. In embodiments, the damping characteristics of rear frame shock absorber 102 are controlled by electronic controller 50 while front track shock absorber 104 is manually adjustable independent of electronic controller 50. In embodiments, the damping characteristics of both rear frame shock absorber 102 front track shock absorber 104 are controlled by electronic controller 50.

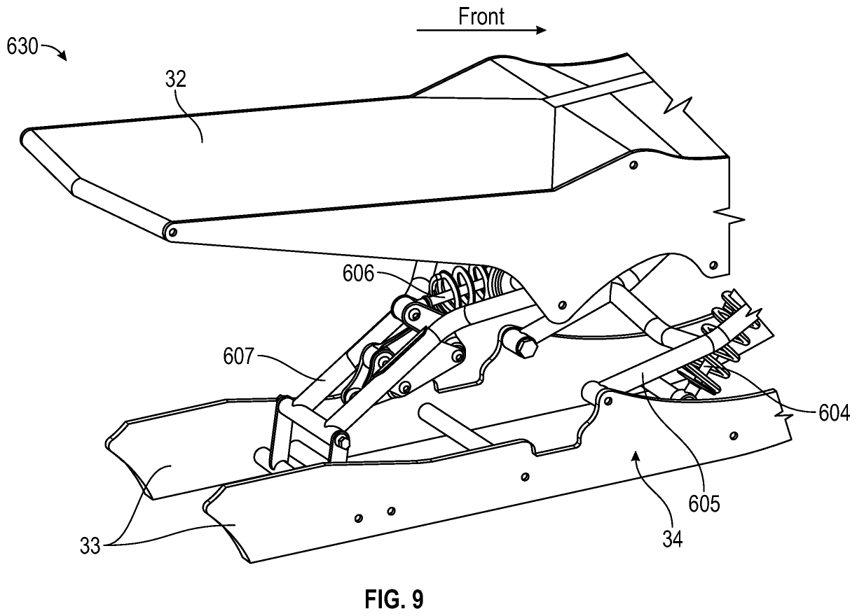

Turning now to FIG. 9, an alternate embodiment of rear suspension assembly 30 will be described in greater detail. In the present embodiment, a rear suspension 630 comprises a front track shock absorber 604 and a rear track shock absorber 606 which provide adjustable damping between tunnel 32 and skid 34. Additionally, a front torque arm 605 and a rear torque arm 607 provide additional support between tunnel 32 and skid 34, and are pivotally coupled therebetween. Additional details regarding rear suspension 630 may be found in U.S. Pat. No. 10,202,169, the entire disclosure of which is expressly incorporated by reference herein. It may be appreciated that rear suspension 630 further comprises rear frame shock absorber 102 (not shown). In embodiments, the damping characteristics of front track shock absorber 604 are controlled by electronic controller 50 while rear frame shock absorber 102 and rear track shock absorber 606 are manually adjustable independent of electronic controller 50. In embodiments, the damping characteristics of rear track shock absorber 606 are controlled by electronic controller 50 while rear frame shock absorber 102 and front track shock absorber 604 are manually adjustable independent of electronic controller 50. In embodiments, the damping characteristics of rear frame shock absorber 102 are controlled by electronic controller 50 while front track shock absorber 604 and rear track shock absorber 606 are manually adjustable independent of electronic controller 50. In embodiments, the damping characteristics of rear frame shock absorber 102 and front track shock absorber 604 are controlled by electronic controller 50 while rear track shock absorber 606 is manually adjustable independent of electronic controller 50. In embodiments, the damping characteristics of front track shock absorber 604 and rear track shock absorber 606 are controlled by electronic controller 50 while rear frame shock absorber 102 is manually adjustable independent of electronic controller 50. In embodiments, the damping characteristics of rear frame shock absorber 102 and rear track shock absorber 606 are controlled by electronic controller 50 while front track shock absorber 604 is manually adjustable independent of electronic controller 50. In embodiments, the damping characteristics of rear frame shock absorber 102, front track shock absorber 604, and rear track shock absorber 606 are controlled by electronic controller 50.

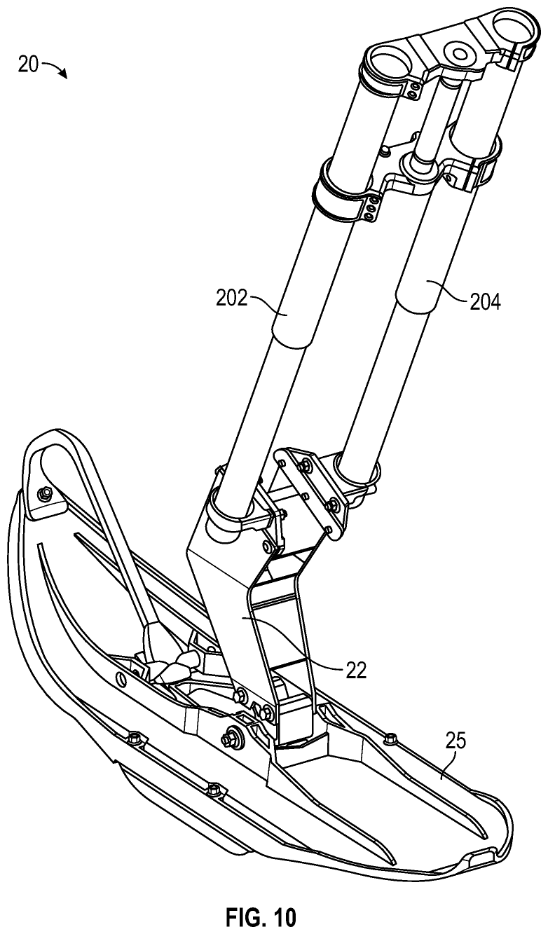

Referring now to FIGS. 10-15, various embodiments of a front suspension 20 will be described in greater detail. Turning to FIG. 10, front suspension 20 comprises first front shock absorber 202 and second front shock absorber 204 which extend generally downward to attach to spindle 22. In this way, spindle 22 couples first front shock absorber 202 and second front shock absorber 204 to ski 25. Front suspension 20 is generally configured as a fork-type suspension. In the present embodiment, first front shock absorber 202 and second front shock absorber 204 are adjustable shock absorbers, and further, first front shock absorber 202 and second front shock absorber 204 are configured to be controlled by electronic controller 50. In embodiments, the damping characteristics of first front shock absorber 202 and second front shock absorber 204 are controlled by electronic controller 50. In embodiments, first front shock absorber 202 and second front shock absorber 204 are coupled together, and as such, the damping characteristics of first front shock absorber 202 and second front shock absorber 204 are controlled such that they remain substantially the same. It may be appreciated that in embodiments, first front shock absorber 202 and second front shock absorber 204 may not be coupled together, and in instances, first front shock absorber 202 and second front shock absorber 204 may be configured such that the damping characteristics of first front shock absorber 202 and second front shock absorber 204 are controlled independently of one another by electronic controller 50.

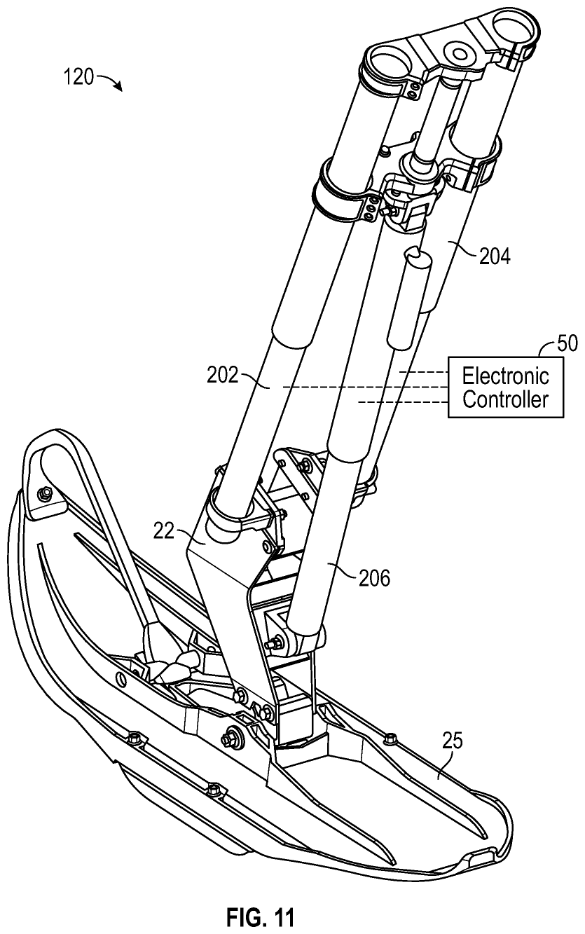

Now referring to FIG. 11, an alternate embodiment of front suspension 20 will be explained in greater detail. In the present embodiment, a front suspension 120 comprises first front shock absorber 202 and second front shock absorber 204 extending generally downward, coupling to spindle 22. Spindle 22 is coupled between first front shock absorber 202, second front shock absorber 204 and ski 25. A third front shock absorber 206 is located longitudinally rearward of first front shock absorber 202 and second front shock absorber 204. In the present embodiment, third front shock absorber 206 is coupled between an upper extent of front suspension 20 and spindle 22. In this way, third front shock absorber 206 may provide additional damping to front suspension 120. In embodiments, all of first front shock absorber 202, second front shock absorber 204, and third front shock absorber 206 are adjustable shock absorbers, wherein the damping characteristics of first front shock absorber 202, second front shock absorber 204, and third front shock absorber 206 may be controlled by electronic controller 50. In embodiments, the damping characteristics of first front shock absorber 202 and second front shock absorber 204 are controlled by electronic controller 50 while third front shock absorber 206 is manually adjustable independent of electronic controller 50. In embodiments, the damping characteristics of third front shock absorber 206 are controlled by electronic controller 50 while first front shock absorber 202 and second front shock absorber 204 are manually adjustable independent of electronic controller 50. In embodiments, the damping characteristics of first front shock absorber 202, second front shock absorber 204 and third front shock absorber 206 are controlled by electronic controller 50.

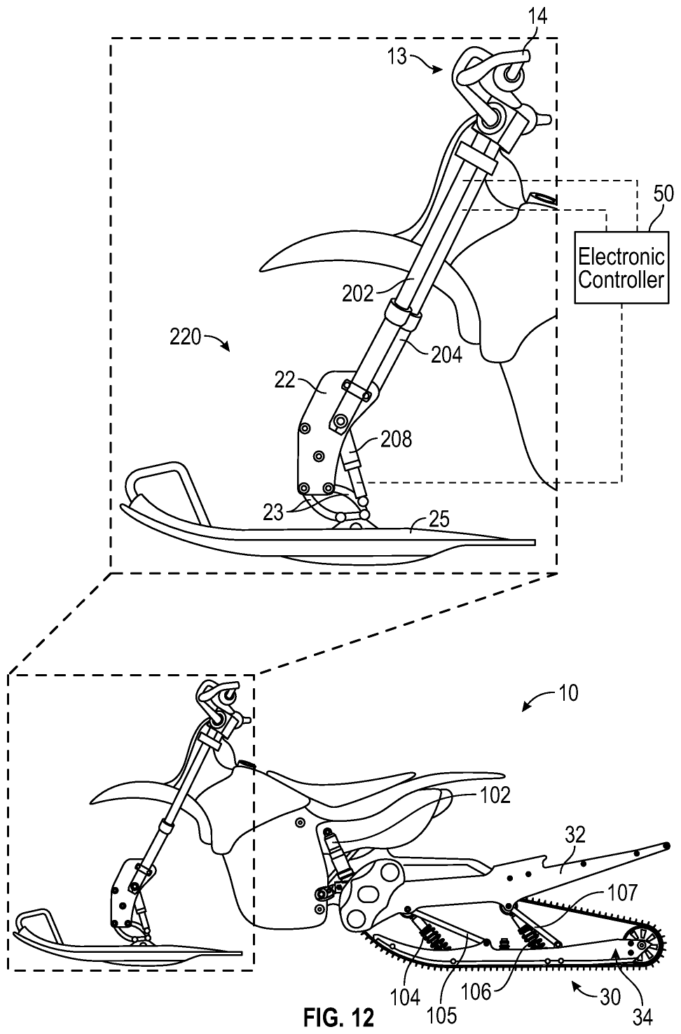

Now referring to FIG. 12, an alternate embodiment of front suspension 20 will be explained in greater detail. In the present embodiment, a front suspension 220 comprises first front shock absorber 202 and second front shock absorber 204 extending generally downward, coupling to spindle 22. A plurality of front control arms 23 are coupled between spindle 22 and ski 25. Further, a fourth front shock absorber 208 is configured to couple between spindle 22 and at least one of the plurality of front control arms 23. In this way, additional damping is provided to front suspension 220, and motion between spindle 22 and ski 25 may be controlled. In embodiments, all of first front shock absorber 202, second front shock absorber 204, and fourth front shock absorber 208 are adjustable shock absorbers, wherein the damping characteristics of first front shock absorber 202, second front shock absorber 204, and fourth front shock absorber 208 may be controlled by electronic controller 50. In embodiments, the damping characteristics of first front shock absorber 202 and second front shock absorber 204 are controlled by electronic controller 50 while fourth front shock absorber 208 is manually adjustable independent of electronic controller 50. In embodiments, the damping characteristics of fourth front shock absorber 208 are controlled by electronic controller 50 while first front shock absorber 202 and second front shock absorber 204 are manually adjustable independent of electronic controller 50. In embodiments, the damping characteristics of first front shock absorber 202, second front shock absorber 204 and fourth front shock absorber 208 are controlled by electronic controller 50.

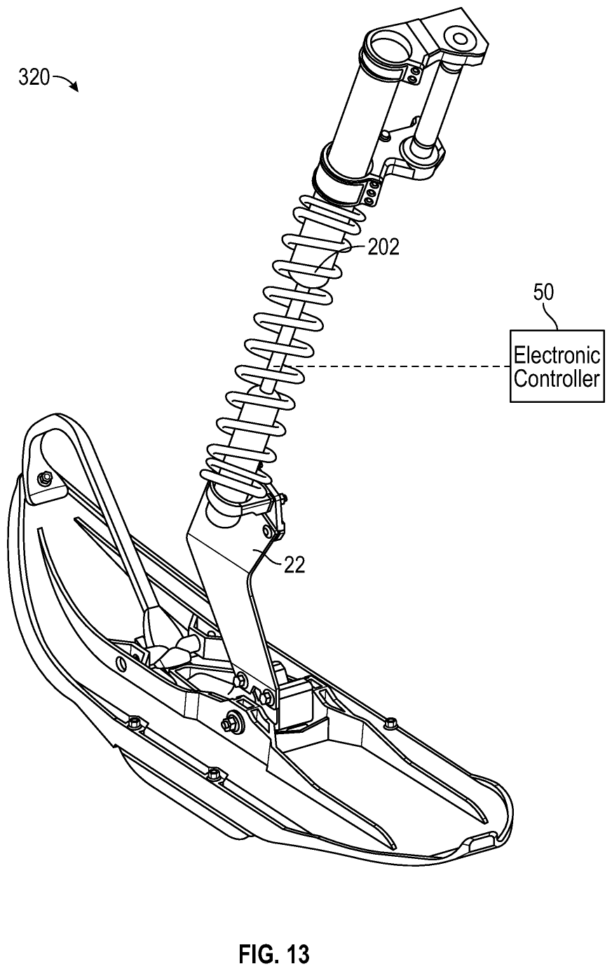

Now referring to FIG. 13, an alternate embodiment of front suspension 20 will be explained in greater detail. In the present embodiment, a front suspension 320 comprises first front shock absorber 202 extending generally downward, and coupling with spindle 22. Spindle 22 is coupled with ski 25. In the present embodiment, first front shock absorber 202 is an adjustable shock absorber and provides adjustable damping to front suspension 320 wherein the damping characteristics of first front shock absorber 202 are controlled by electronic controller 50. In various embodiments, front suspension 320 may further comprise fourth front shock absorber 208 (not shown), coupled between spindle 22 and ski 25. In embodiments, the damping characteristics of first front shock absorber 202 are controlled by electronic controller 50 while fourth front shock absorber 208 is manually adjustable independent of electronic controller 50. In embodiments, the damping characteristics of fourth front shock absorber 208 are controlled by electronic controller 50 while first front shock absorber 202 is manually adjustable independent of electronic controller 50.

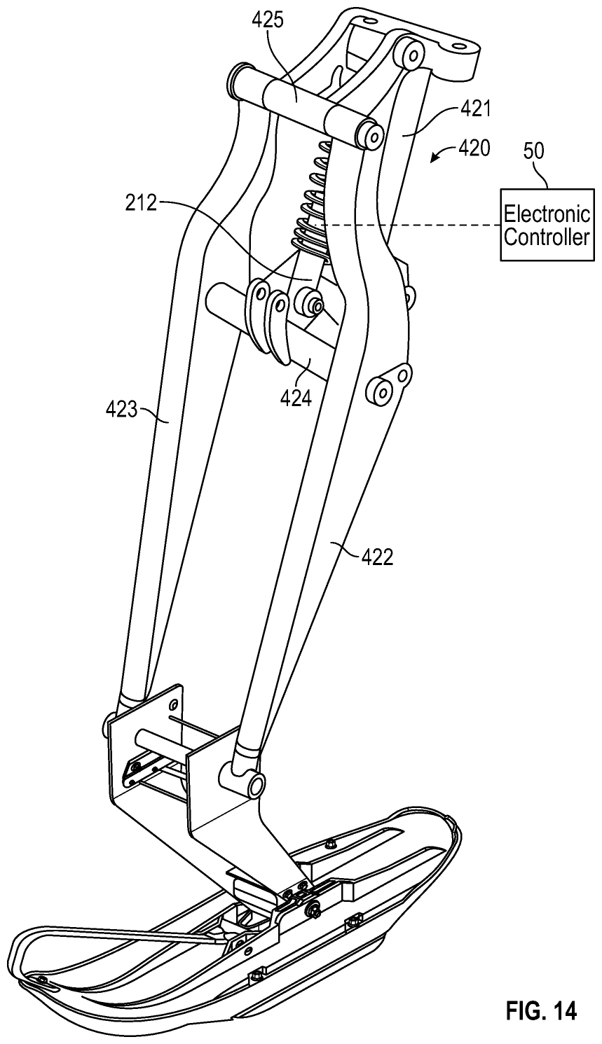

Now referring to FIG. 14, an alternate embodiment of front suspension 20 will be explained in greater detail. In the present embodiment, a front suspension 420 is a girder-style suspension. Illustratively, front suspension 420 comprises a rear down tube 421, a first forward down tube 422, and a second forward down tube 423. In the present embodiment, tube 422 and tube 423 are coupled to spindle 22 at their lower extents, and spindle 22 is coupled to ski 25. In the present embodiment, tube 422 and tube 423 are coupled at a generally vertically intermediate portion by a first cross tube 424. Further, tube 422 and tube 423 are coupled at their upper extents by a first cross tube 425, wherein first cross tube 425 comprises a rotational axis about which tube 421 may rotate relative to tube 422 and tube 423. A fifth front shock absorber 212 is coupled between first cross tube 424 and an upper extent of tube 421. In this way, fifth front shock absorber 212 provides adjustable damping between tube 421 and ski 25. In embodiments, the damping characteristics of fifth front shock absorber 212 are controlled by electronic controller 50.

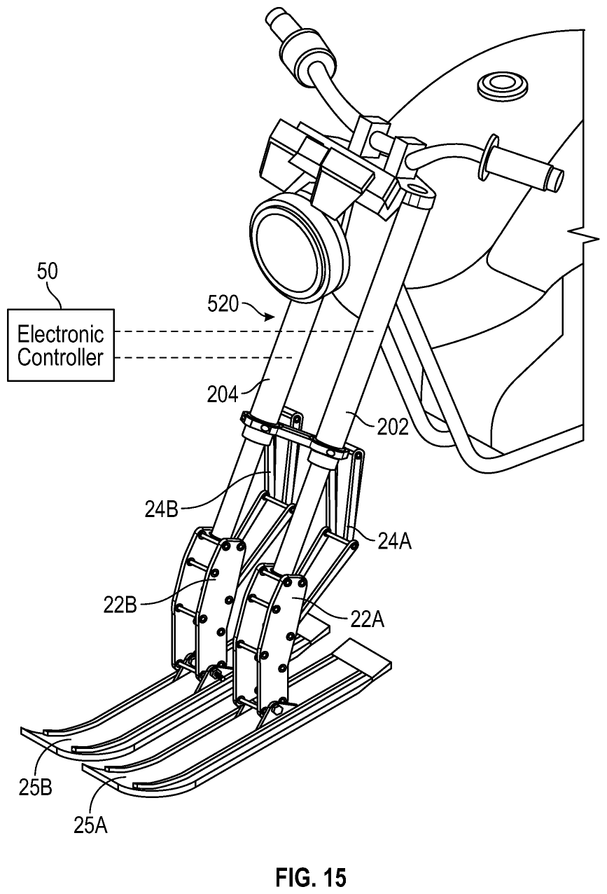

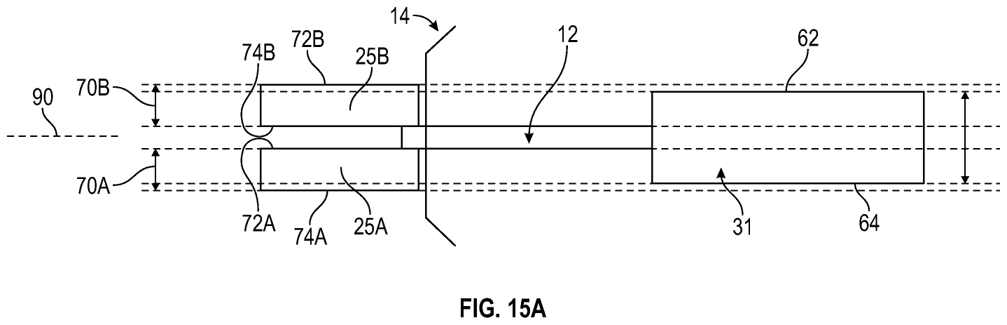

Now referring to FIG. 15, an alternate embodiment of front suspension 20 will be explained in greater detail. In the present embodiment, a front suspension 520 comprises first front shock absorber 202 and second front shock absorber 204. Further, first front shock absorber 202 extends downward to couple to a spindle 22A, and second front shock absorber 204 extends downward to a spindle 22B. In the present embodiment, spindle 22A couples to a ski 25A and spindle 22B couples to a ski 25B. Front suspension 520 is generally configured as a fork-type suspension with a plurality of skis. Further, front suspension 520 is configured with a first support 24A and a second support 24B, wherein first support 24A is configured to couple between first front shock absorber 202 and spindle 22A, and second support 24B is configured to couple between second front shock absorber 204 and spindle 22B. In the present embodiment, first front shock absorber 202 and second front shock absorber 204 are adjustable shock absorbers, and further, first front shock absorber 202 and second front shock absorber 204 are configured to be controlled by electronic controller 50. In embodiments, the damping characteristics of first front shock absorber 202 and second front shock absorber 204 are controlled by electronic controller 50. In embodiments, first front shock absorber 202 and second front shock absorber 204 are coupled together, and the damping characteristics of first front shock absorber 202 and second front shock absorber 204 are controlled such that they remain substantially the same. In embodiments, first front shock absorber 202 and second front shock absorber 204 may not be coupled together and may move relative to each other and first front shock absorber 202 and second front shock absorber 204 may be configured such that the damping characteristics of first front shock absorber 202 and second front shock absorber 204 are controlled independently of one another by electronic controller 50.

Referring to FIG. 15A, endless track 31 has an endless track width 60 defined between a first lateral side 62 of the endless track 31 and a second lateral side 64 of the endless track 31. Each of skis 25A, 25B is positioned forward of endless track 31. Skis 25A, 25B have respective ski widths 70A, 70B defined between a first lateral side 72A, 72B and a second lateral side 74A, 74B.

Rear frame shock absorber 102, front track shock absorber 104, rear track shock absorber 106, first front shock absorber 202, second front shock absorber 204, and any other adjustable shock absorbers disclosed herein are adjustable shock absorbers, the damping characteristics of which are continuously controlled by an electronic controller 50. In embodiments, endless track 18 includes one adjustable shock absorbers and a standard shock absorber, such as a manually adjustable shock absorber. In embodiments, electronic controller 50 updates the damping characteristics of first front shock absorber 202, second front shock absorber 204, rear frame shock absorber 102, front track shock absorber 104, and rear track shock absorber 106 during movement of snowbike 10, 10′. Electronic controller 50 continuously controls first front shock absorber 202, second front shock absorber 204, rear frame shock absorber 102, front track shock absorber 104, rear track shock absorber 106 by updating the desired damping characteristics of first front shock absorber 202, second front shock absorber 204, rear frame shock absorber 102, front track shock absorber 104, rear track shock absorber 106 based on monitored sensor values, received operator inputs, and/or other inputs at discrete instances of time. An exemplary time interval is about 1 milli-seconds to about 5 milliseconds. For example, electronic controller 50 updates targets for each of first front shock absorber 202, second front shock absorber 204, rear frame shock absorber 102, front track shock absorber 104, rear track shock absorber 106 about every 5 milliseconds and updates the current control loop about every milli-second.

In embodiments, first front shock absorber 202, second front shock absorber 204, rear frame shock absorber 102, front track shock absorber 104, rear track shock absorber 106 include solenoid valves mounted at the base of the shock body or internal to a damper piston of the respective first front shock absorber 202, second front shock absorber 204, rear frame shock absorber 102, front track shock absorber 104, rear track shock absorber 106. The stiffness of the shock absorber is increased or decreased by introducing additional fluid to the interior of the shock absorber, removing fluid from the interior of the shock absorber, and/or increasing or decreasing the ease with which fluid can pass from a first side of a damping piston of the shock absorber to a second side of the damping piston of the shock absorber. In another embodiments, first front shock absorber 202, second front shock absorber 204, rear frame shock absorber 102, front track shock absorber 104, rear track shock absorber 106 include a magnetorheological fluid internal to the respective first front shock absorber 202, second front shock absorber 204, rear frame shock absorber 102, front track shock absorber 104, rear track shock absorber 106. The stiffness of the shock is increased or decreased by altering a magnetic field experienced by the magnetorheological fluid. Additional details on exemplary adjustable shocks are provided in US Published Patent Application No. 2016/0059660, filed Nov. 6, 2015, titled VEHICLE HAVING SUSPENSION WITH CONTINUOUS DAMPING CONTROL, assigned to the present assignee, the entire disclosure of which is expressly incorporated by reference herein. In one embodiment, first front shock absorber 202, second front shock absorber 204, rear frame shock absorber 102, front track shock absorber 104, rear track shock absorber 106 each include a first controllable proportional valve to adjust compression damping and a second controllable proportional valve to adjust rebound damping. In another embodiment, first front shock absorber 202, second front shock absorber 204, rear frame shock absorber 102, front track shock absorber 104, rear track shock absorber 106 each include a combination proportional valve which controls both compression damping and rebound damping.

In various embodiments, the various front suspension arrangements, illustratively front suspension 20, front suspension 120, front suspension 220, front suspension 320, front suspension 420, front suspension 520 may each be combined with any of the various rear suspension arrangements, illustratively rear suspension assembly 30, rear suspension 130, rear suspension 230, rear suspension 330, rear suspension 430, rear suspension 530, rear suspension 630. It may be appreciated that any or all of the shock absorbers present in various suspension arrangements may be adjustable shock absorbers. In embodiments, any of the various front suspension arrangements may comprise a plurality of adjustable shock absorbers first front shock absorber 202, second front shock absorber 204, third front shock absorber 206, fourth front shock absorber 208, fifth front shock absorber 212 wherein the damping characteristics of a portion of first front shock absorber 202, second front shock absorber 204, third front shock absorber 206, fourth front shock absorber 208, fifth front shock absorber 212 are controlled by electronic controller 50. In embodiments, any of the various rear suspension arrangements may comprise a plurality of adjustable shock absorbers including rear frame shock absorber 102, front track shock absorber 104, rear track shock absorber 106, intermediate track shock absorber 108 wherein the damping characteristics of a portion of rear frame shock absorber 102, front track shock absorber 104, rear track shock absorber 106, intermediate track shock absorber 108 are controlled by electronic controller 50. In embodiments, the damping characteristics of a portion of first front shock absorber 202, second front shock absorber 204, third front shock absorber 206, fourth front shock absorber 208, fifth front shock absorber 212 are controlled by electronic controller 50 while a portion of rear frame shock absorber 102, front track shock absorber 104, rear track shock absorber 106, intermediate track shock absorber 108 are manually adjustable independent of electronic controller 50. In embodiments, the damping characteristics of a portion of rear frame shock absorber 102, front track shock absorber 104, rear track shock absorber 106, intermediate track shock absorber 108 are controlled by electronic controller 50 while a portion of first front shock absorber 202, second front shock absorber 204, third front shock absorber 206, fourth front shock absorber 208, fifth front shock absorber 212 are manually adjustable independent of electronic controller 50. In embodiments, the damping characteristics of a portion of first front shock absorber 202, second front shock absorber 204, third front shock absorber 206, fourth front shock absorber 208, fifth front shock absorber 212, rear frame shock absorber 102, front track shock absorber 104, rear track shock absorber 106, intermediate track shock absorber 108 are controlled by electronic controller 50.

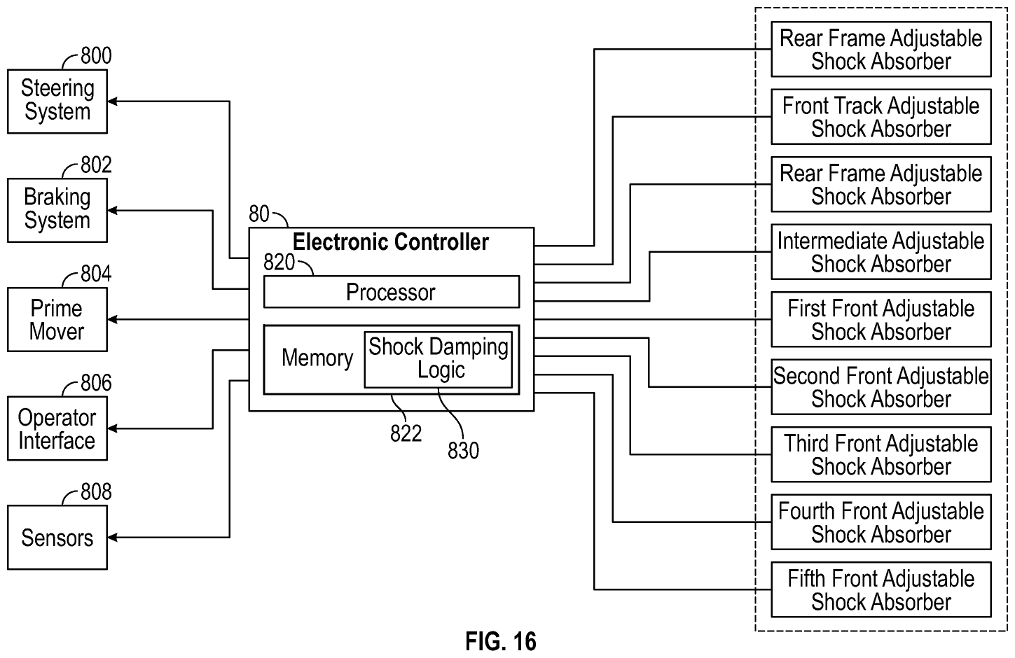

Referring to FIG. 16, electronic controller 50 is operatively coupled to a steering system 800, a braking system 802, a prime mover 804, an operator interface 806, and a plurality of sensors 808. Steering system 800 is used to control an orientation of snowbike 10 as it moves across the ground and may include a front ski 25 and handlebars in an embodiment. Braking system 802 is used to assist in the deceleration of snowbike 10 and may include a disk brake operatively coupled to endless track 31 and a brake hand lever or brake pedal to receive an input from the operator to brake snowbike 10. Prime mover 804 is used to accelerate snowbike 10 by powering a rotation of endless track 31 and may be responsive to a throttle input lever, twist grip, or pedal. Operator interface 806 includes one or more operator inputs and outputs to allow an operator to provide instruction to snowbike 10 and receive information regarding the operation of snowbike 10. Exemplary input devices include buttons, levers, pedals, touch display, microphones, and other suitable input devices. Exemplary output devices include gauges, lights, speakers, displays and other suitable output devices. Sensors 808 monitor various parameters of snowbike 10 or the environment surrounding snowbike 10. Exemplary sensors 808 include a global positioning sensor (GPS), an inertial measurement unit (“IMU”), one or more acceleration sensors, one or more gyroscopes, an engine speed sensor, a brake switch, a brake pressure sensor, a steering angle sensor, a transmission gear selection sensor, a throttle position sensor, a vehicle speed sensor, an air pressure sensor.

Electronic controller 50 includes at least one processor 820 and at least one non-transitory computer readable medium, memory 822. In embodiments, electronic controller 50 is a single unit that controls the operation of various systems of snowbike 10. In embodiments, electronic controller 50 is a distributed system comprised of multiple controllers each of which control one or more systems of snowbike 10 and may communicate with each other over one or more wired and/or wireless networks. For example, electronic controller 50 may include a suspension controller which controls the damping characteristics of each of the adjustable shocks of snowbike 10 and an engine controller which controls the operator of a prime mover prime mover 804 of snowbike 10.

Electronic controller 50 includes shock damping logic 830 which controls the damping characteristics of the adjustable shocks of snowbike 10. The term “logic” as used herein includes software and/or firmware executing on one or more programmable processors, application-specific integrated circuits, field-programmable gate arrays, digital signal processors, hardwired logic, or combinations thereof. Therefore, in accordance with the embodiments, various logic may be implemented in any appropriate fashion and would remain in accordance with the embodiments herein disclosed. A non-transitory machine-readable medium comprising logic can additionally be considered to be embodied within any tangible form of a computer-readable carrier, such as solid-state memory, magnetic disk, and optical disk containing an appropriate set of computer instructions and data structures that would cause a processor to carry out the techniques described herein. This disclosure contemplates other embodiments in which electronic controller 50 is not microprocessor-based, but rather is configured to control operation of the adjustable shocks of snowbike 10 based on one or more sets of hardwired instructions.

In embodiments, shock damping logic 830 includes logic to reduce compression of the adjustable shocks from the front suspension of snowbike 10 at vehicle speeds below a threshold and to stiffen the adjustable shocks at vehicle speeds above a threshold (either the same threshold or separate threshold so that a baseline compression damping is provided between the thresholds). In embodiments, rear suspension 130 includes multiple modes that may be selected by an operator through operator interface 806, each mode having respective baseline damping characteristics for the adjustable shocks of snowbike 10. In embodiments, shock damping logic 830 includes logic to raise the compression damping and/or reduce rebound damping for the adjustable shocks of snowbike 10 when electronic controller 50 determines snowbike 10 is airborne. Various techniques for detecting an airborne condition of an off-road vehicle are provided in US Published Patent Application No. 2016/0059660, filed Nov. 6, 2015, titled VEHICLE HAVING SUSPENSION WITH CONTINUOUS DAMPING CONTROL and U.S. Pat. No. 9,381,810, filed Jun. 3, 2011, titled ELECTRONIC THROTTLE CONTROL, the entire disclosures of which are expressly incorporated by reference herein.

While embodiments of the present disclosure have been described as having exemplary designs, the present invention may be further modified within the spirit and scope of this disclosure. This application is therefore intended to cover any variations, uses, or adaptations of the disclosure using its general principles. Further, this application is intended to cover such departures from the present disclosure as come within known or customary practice in the art to which this invention pertains.

1. A tracked vehicle having a vertical longitudinal vehicle centerline plane, comprising:
a plurality of ground engaging members, the plurality of ground engaging members including an endless track having an endless track width defined between a first lateral side of the endless track and a second lateral side of the endless track and a ski positioned forward of the endless track, wherein the ski has a ski width defined between a first lateral side of the ski and a second lateral side of the ski, the first lateral side of the ski being positioned between the vertical longitudinal vehicle centerline plane and the first lateral side of the endless track;
a frame supported by the plurality of ground engaging members;
a plurality of suspensions comprising:
a first suspension coupling the ski to the frame; and
a second suspension positioned within an interior of the endless track, wherein at least one of the plurality of suspensions includes at least one adjustable shock absorber having at least one adjustable damping characteristic;
an electronic controller supported by the plurality of ground engaging members and operatively coupled to the at least one adjustable shock absorber to control the at least one adjustable damping characteristic of the at least one adjustable shock absorber;
a straddle seat supported by the frame;
a prime mover operatively coupled to the endless track to power movement of the endless track; and
a steering input operatively coupled to the ski to control an orientation of the ski.

2. The tracked vehicle of claim 1, wherein the plurality of suspensions further comprises a third suspension coupling the endless track to the frame, one of the first suspension and the second suspension including a first adjustable shock absorber of the at least one adjustable shock absorber and the third suspension includes a third suspension adjustable shock absorber of the at least one adjustable shock absorber.

3. The tracked vehicle of claim 1, wherein the second lateral side of the ski is positioned between the vertical longitudinal vehicle centerline plane and one of the first lateral side of the endless track and the second lateral side of the endless track.

4. The tracked vehicle of claim 1, wherein the first lateral side of the ski is positioned on a first side of the vertical longitudinal vehicle centerline plane and the second lateral side of the ski is positioned on a second side of the vertical longitudinal vehicle centerline plane.

5. The tracked vehicle of claim 1, wherein the ski width is centered about the vertical longitudinal vehicle centerline plane.

6. The tracked vehicle of claim 1, wherein the endless track width is centered about the vertical longitudinal vehicle centerline plane.

7. The tracked vehicle of claim 1, wherein both the first lateral side of the ski and the second lateral side of the ski are positioned on one of a first side of the vertical longitudinal vehicle centerline plane and a second side of the vertical longitudinal vehicle centerline plane.

8. The tracked vehicle of claim 7, wherein the ski is a first ski positioned completely on the first side of the vertical longitudinal vehicle centerline plane and the plurality of ground engaging members further includes a second ski positioned completely on the second side of the vertical longitudinal vehicle centerline plane.

9. The tracked vehicle of claim 8, wherein the first suspension couples the first ski to the frame and the plurality of suspensions further comprises a fourth suspension coupling the second ski to the frame.

10. The tracked vehicle of claim 1, further comprising an operator input actuatable by an operator to alter the at least one adjustable damping characteristic of the at least one adjustable shock absorber.

11. The tracked vehicle of claim 10, wherein the in response to an actuation of the operator input a compression damping characteristic of the at least one adjustable shock absorber is stiffened.

12. The tracked vehicle of claim 10, wherein the first suspension includes a first suspension adjustable shock absorber of the at least one adjustable shock absorber and in response to an actuation of the operator input a compression damping characteristic of the first suspension adjustable shock absorber is stiffened.

13. The tracked vehicle of claim 10, wherein the second suspension includes a second suspension adjustable shock absorber of the at least one adjustable shock absorber and in response to an actuation of the operator input one of a compression damping characteristic of the second suspension adjustable shock absorber and a rebound damping characteristic of the second suspension adjustable shock absorber is altered.

14. The tracked vehicle of claim 10, wherein the plurality of suspensions comprises a third suspension and the third suspension comprises a third suspension adjustable shock absorber, and in response to an actuation of the operator input one of a compression damping characteristic of the third suspension adjustable shock absorber and a rebound damping characteristic of the third suspension adjustable shock absorber is altered.

15. The tracked vehicle of claim 1, further comprising at least one sensor supported by the plurality of ground engaging members and operatively coupled to the electronic controller to alter the at least one adjustable damping characteristic of the at least one adjustable shock absorber.

16. The tracked vehicle of claim 15, wherein in response to a vehicle characteristic determined by the electronic controller based on the at least one sensor a compression damping characteristic of the at least one adjustable shock absorber is stiffened.

17. The tracked vehicle of claim 15, wherein the first suspension includes a first suspension adjustable shock absorber of the at least one adjustable shock absorber and in response to a vehicle characteristic determined by the electronic controller based on the at least one sensor, a compression damping characteristic of the at least one adjustable shock absorber is stiffened.

18. The tracked vehicle of claim 15, wherein the second suspension includes a second suspension adjustable shock absorber of the at least one adjustable shock absorber and in response to a vehicle characteristic determined by the electronic controller based on the at least one sensor one of a compression damping characteristic of the second suspension adjustable shock absorber and a rebound damping characteristic of the second suspension adjustable shock absorber is altered.

19. The tracked vehicle of claim 15, wherein the plurality of suspensions comprises a third suspension and the third suspension comprises a third suspension adjustable shock absorber, and in response to a vehicle characteristic determined by the electronic controller based on the at least one sensor one of a compression damping characteristic of the third suspension adjustable shock absorber and a rebound damping characteristic of the third suspension adjustable shock absorber is altered.

20. The tracked vehicle of claim 19, wherein the vehicle characteristic is one of a speed of the tracked vehicle, an acceleration of the tracked vehicle, a braking of the tracked vehicle, an airborne status of the tracked vehicle, and a turning of the tracked vehicle.
